(19) United States
(12) Patent Application Publication
(10) Pub. No.: US 2013/0186078 A1
(43) Pub. Date: Jul. 25, 2013

(54) MICRO-VALVE HAVING AN ELASTICALLY DEFORMABLE VALVE LIP, METHOD FOR PRODUCING SAME AND MICRO-PUMP

(71) Applicants: Thomas Lemke, Freiburg (DE); Peter Woias, Freiburg (DE); Jens Kiöker, Lenzkirch (DE); Frank Goldschmidtooing, Waldkirch (DE)

(72) Inventors: Thomas Lemke, Freiburg (DE); Peter Woias, Freiburg (DE); Jens Kiöker, Lenzkirch (DE); Frank Goldschmidtooing, Waldkirch (DE)

(73) Assignee: ALBERT-LUDWIGS-UNIVERSITAT FREIBURG, Freiburg (DE)

(21) Appl. No.: 13/640,249

(22) PCT Filed: Apr. 7, 2011
(86) PCT No.: PCT/EP2011/001743

§ 371 Date: Feb. 14, 2013

(30) Foreign Application Priority Data
Apr. 9, 2010 (DE) 102010014308.1
Jul. 30, 2010 (DE) 102010032799.9

(51) Int. Cl. F16K 27/00; F17D 1/00; F15B 13/00; B21K 1/20

(52) U.S. Cl. CPC F16K 27/00; B21K 1/20; F17D 1/00; F15B 13/00
USPC 60/325; 29/890.124; 251/357; 137/565.01

(57) ABSTRACT

The present invention relates to a micro-valve which is formed from two firmly connected substrates and preferably has an actuator element, for example that is diaphragm-driven, for the controlled opening and closing of a first and/or second passage. The invention further relates to a method for producing such a micro-valve and to a micro-pump which uses at least one such micro-valve. Said micro-pump is intended to be used in particular in conjunction with the development of an artificial sphincter. The micro-valve has a first substrate and a second substrate which are non-detachably joined to each other in order to form a controllable fluid flow section, and at least one first passage and at least one second passage. According to the invention, the micro-valve has at least one elastically deformable seal structure which, for example, can be formed by a photostructurable silicone, to seal off the first and/or second passage.

### FIELD OF THE INVENTION

The present invention relates to a micro-valve which is formed from two firmly connected substrates and preferably has an actuator element, for example that is diaphragm-driven, for the controlled opening and closing of a first and/or second passage. The invention further relates to a method for producing such a micro-valve and to a micro-pump which uses at least one such micro-valve. Said micro-pump is intended to be used in particular in conjunction with the development of a hydraulic muscle (for example a sphincter) for the treatment of urinary and fecal incontinence or erectile dysfunction.

### BACKGROUND OF THE INVENTION

During the last 20 years, a plurality of different types of micro-valves have been developed in the field of microfluidics, as is evident for example, from the review article Oh, K W et al.: “A review of micro valves”, Journal of Micromechanics and Microengineering, 16 (2006), R13-R39. Generally, micro-valves can be divided into active and passive valves, where a passive valve is unidirectional, since the state of the passive valve is dependent on the pressure difference applied. If the pressure at the outlet is higher than at the inlet, then a passive valve shuts. If the pressure at the outlet is lower than at the inlet, then the valve allows passage. So-called nozzle diffuser valves are an alternative embodiment, which in the passage direction have a substantially larger through flow than in the reverse direction. Active valves, however, can be opened and closed independently of the inlet and outlet pressure. This is usually done by means of an electronic control, for example, via piezoelectric or electromagnetic drives. For active valves, there is in principle the possibility to allow for through flow in both directions. Due to this bi-directionality, the inlet and outlet are no longer statically defined, but depend on the operating state of the valve.

With many active valves, a diaphragm is deflected to open or to close the valve. In this, a large number of actuating principles are used. Furthermore, one can distinguish active valves as normal-open, normal-closed and bi-stable valves. Bi-stable valves are such valves which have two stable states and combine the properties of normal-open and normal-closed valves.

Micro-valves can be used for a variety of different applications, such as for example, micro-dosing, drug release, bioanalysis or in so-called “micro total analysis systems” (μTAS) that automatically perform all the steps necessary for the chemical analysis of a substance.

### SUMMARY OF THE INVENTION

The present invention is generally restricted neither to the type of valve nor to the application, but shall be shown in the following by way of example for a normal-closed active valve, as it is applicable for a so-called “artificial sphincter system”, a medical sphincter prosthesis. Known micro-valves and micro-pumps, as shown for example in DE 10 2005 038 483 B3, have two joined substrates with respective passage openings and valve lips surrounding the passage openings, and by operating the diaphragm region serve to close the openings through which are carved out as projections from the substrate material by means of micro-mechanical etching techniques. It has been shown that with such micro-valves, the repeated impact of the diaphragm onto the comparably hard seat valve can lead to permanent damage to the valve seat. In the course of time, this causes irreparable failure of the system due to decreasing leak tightness. Particularly for implantable micro-systems, however, like the sphincter prosthesis, the longest possible maintenance-free operation time is essential.

The present invention is therefore based on the idea to provide an elastically deformable valve lip for a valve, which is manufactured using micro-system technology, for sealing at least one of the passage openings. With such an elastically deformable valve lip, firstly excessive wear of the materials can be prevented during operation and, secondly, by balancing substrate unevenness or flexible adaptation to structuring tolerances, much improved leak tightness of the valve in the closed state can be created.

As material for such a valve lip, a polymer can advantageously be considered having an E-modulus of at most about 500 MPa, in order to ensure sufficient deformability and damping. The valve lip is manufactured in one piece from this polymer material, according to the invention in a single photolithography step. Although other materials with the required elasticity can be used, photo-structurable silicone provides having an E-modulus of about 160 MPa is very suitable sealing material.

According to an advantageous embodiment, the valve lip is under mechanical pre-load when in a closed position. Due to the contact pressure generated thereby and the resulting elastic deformation of the sealing lip, particularly reliable sealing can be ensured.

According to one advantageous embodiment of the invention, the micro-valve according to the invention is an active valve and comprises at least one actuator element for the controlled opening and closing of the first and/or second passage. Such active valves provide the advantage, as already mentioned, that they are bi-directional and can be used for example for realizing a bidirectional micro-pump. For a person skilled in the art, it is of course evident that the principles of the invention are likewise applicable to a passive valve.

It is necessary for various applications, that a micro-valve without expenditure of energy remain in the closed state and must be actuated only for opening. Such normal-closed valves are required, for example, for the above-mentioned sphincter prosthesis. According to an advantageous development of the micro-valve according to the invention, the actuator element is operative for opening the first and/or second passage so that a normal-closed micro-valve can be formed. This significantly reduces energy consumption in an advantageous manner for all applications in which a closed state of the valve is required for the predominant part of the operating time.

According to the present invention, the valve lip is formed in a planar technology manufacturing step on the first and/or second substrate. This solution allows particularly low-cost manufacturing, as planar technology steps can be provided as part of the micro-mechanical manufacturing process and allow the manufacturing of disks and batch processes. In particular when the valve lip is formed from a photo-lithographically structured silicone layer, particularly precise and defined shaping of the sealing valve lip can be achieved.

For example, the valve lip can be formed in one piece such that the respective passage opening closes in a circumferentially sealing manner. This permits particularly secure sealing of the valve in the closed state with long-term stability. Simultaneously, it can be sealed against high back pressures.

In plan view, the valve lip can have a wide range of geometries. Intensive studies and positive results were for instance performed with annular-shaped valve lips. However, any other base shape, for example, a rectangular or polygonal structure, just like an oval and other elongated cross-sections can of course be selected.

According to an alternative embodiment, the valve lip has a multi-part design. For example, a plurality of column-like sealing elements can be provided in an off-set arrangement. In the mechanically unloaded state, they form passage paths with low fluidic resistance and in the mechanically loaded state, block the fluid path due to greatly increased fluidic resistance. In this manner, for example, a toothed structure can also be achieved, in that one part of the sealing elements is arranged on one substrate and another part on the opposite substrate. The interaction of sealing elements on two substrate sides can of course also be used in the case of circumferential seals.

The advantage of such a combined design is the option to respond more flexible to manufacturing tolerances, and in the case of seals applied on both sides, the option to achieve improved sealing due to the interaction of two elastically deformable elements.

The advantageous properties of the micro-valve structure according to the invention particularly come into play when the micro-valve is fitted with a piezoelectrically or electro-magnetically actuatable deflectable diaphragm for opening and closing the first and/or second passage. Such a diaphragm structure can be very easily integrated into the planar technology manufacturing process and the required strokes can be easily reached in this manner.

In particular, micro-pumps, having high back pressure stability, a low leakage rate and high energy efficiency while simultaneously being small in size, can be designed using the micro-valve according to the invention.

In this, this pump can comprise one or more of the micro-valves, as described in DE 10 2005 038 483 B3 by way of example for a two-chamber micro-pump. The micro-pump according to the invention is advantageous in particular for the application in an artificial sphincter system. This is a medical sphincter prosthesis whose core element is a peristaltic micro-pump. This pump pumps a liquid medium from the so-called reservoir into a compressible inflatable body or vice versa.

In this system, e.g. known from DE 102004018807 B4 and hereinafter referred to as GASS (German Artificial Sphincter System), two stable states are distinguished which are shown schematically in FIGS. 37 and 38. In the defecation state, the larger part of the liquid volume is located in the reservoir, whereas in the continence state the compressible inflatable bodies sealing the rectum are filled with the liquid. In these two states, the valves of the system are closed, so that no transfer of liquid can occur between the inflatable body and the reservoir. A pressure created by the pump is maintained in the continence state, whereas in the defection state, the return flow of the liquid into the compressible inflatable body is avoided. By means of the valve according to the invention, firstly a normal-closed system can be realized, where energy must be expended only during the periods in which there is a transition from one to the other state, whereas no more energy is required for maintaining the respectively set final state. Furthermore, the good sealing properties of the valve assembly according to the invention prevent unwanted passing-over of the liquid from the compressible inflatable body into the reservoir and vice versa, and thereby undesirable pressure losses.

Furthermore, in particular with implanted systems, long operating life is desired and the valve according to the invention has a much longer service life because when closing, no hard/hard impact of functional silicon structures occurs, as is the case with the valve known from DE 10 2005 038 483 B3.

According to an advantageous embodiment of the present invention, when joining the first and second substrate, mechanical pressure is exerted upon the valve lip, so that it is deformed in the closed state. This pressing allows the production of a particularly tight normal-closed valve.

To ensure a defined pressure force in the production, basically two different approaches can be taken: Firstly, a firm connection between the two substrates can be achieved by an adhesive bonding layer. In this case, the degree of deformation obtained in the closed position can be set by means of the height of the bonding layer and the height of the sealing structure. Alternatively, the two substrates, however, can be joined to each other by a direct bonding process with an appropriate temperature budget. In this case, the degree of deformation of the valve lip in the closed state can be set for one or both substrate surfaces by a defined etching pit or defined etching for producing a cavity having a defined depth, etc.

Basically, the use of actuators with great force and long stroke is advantageous. A piezoelectric bending converter is presently particularly suitable and also well studied. However, other drive principles are also possible, for example, using compressed air or electrostatic or electromagnetic actuator principles. Any other drive form in which a flexible diaphragm is movable for opening and closing the valve is of course likewise employable for the micro-valve according to the invention.

It may further be necessary for various applications to operate the micro-valve according to the invention with chemically aggressive or biologically contaminated media. In particular, the demand for decontamination and sterilization by appropriately aggressive chemical agents may also be given. In these cases, the problem can arise that the connection regions between the first and second substrate and in particular the bonding layer may be affected by the media filled in. In the worst case, such a chemical attack on the bonding layer causes failure of the component.

It is therefore provided in an advantageous development of the present invention, that alternatively or in addition to the elastic sealing of the first and/or second passage, at least one further elastically deformable sealing structure is arranged at the edge regions of the valve chamber and/or at the edge regions of the component towards the exterior by means of which in particular the bonding layer can be protected from the conveyed media.

According to the present invention, such a sealing seal structure is formed circumferentially, closed, flexible and deformable, and is for example made from photo-structurable silicone. Such a sealing seal structure ensures chemical resistance, for example, against etching media being transported through the micro-valve or the micro-pump and also improves usability for biological applications.

### BRIEF DESCRIPTION OF THE DRAWINGS

To better understand the present invention, it is illustrated in detail by means of the embodiments illustrated in the figures below. These same elements are designated with the same reference numerals and the same component designations. Furthermore, individual features or feature combinations from the embodiments shown and described can themselves constitute independent inventive solutions or solutions according to the invention.

FIG. 1 shows a perspective view of a micro-valve in the closed state;

FIG. 2 shows a perspective view of the micro-valve of FIG. 1 in the opened state;

FIG. 3 shows a detailed view of the valve of FIG. 1;

FIG. 4 shows a detailed view of the valve of FIG. 2;

FIG. 5 shows a micro-valve according to another embodiment in the closed state;

FIG. 6 shows a perspective view of the micro-valve of FIG. 5 in the opened state;

FIG. 7 shows a first substrate in the initial state;

FIG. 8 shows the first substrate after the growth of moist oxide and the deposition of silicon nitride;

FIG. 9 shows the first substrate after structuring a photoresist;

FIG. 10 shows the first substrate after dry etching;

FIG. 11 shows the first substrate after removing the photoresist;

FIG. 12 shows the first substrate after time-controlled KOH-wet etching;

FIG. 13 shows the first substrate after an HF-etching step;

FIG. 14 shows the first substrate after vapor coating a metallization layer;

FIG. 15 shows the first substrate after the photolithographic structuring of spin-coated silicone;

FIG. 16 shows a second substrate in the initial state;

FIG. 17 shows the second substrate after the growth of moist oxide and the deposition of silicon nitride;

FIG. 18 shows the second substrate after applying and structuring a photoresist;

FIG. 19 shows the second substrate after a dry etching step;

FIG. 20 shows the second substrate after removing the photoresist;

FIG. 21 shows the second substrate after time controlled KOH wet etching;

FIG. 22 shows the second substrate after an HF-etching step;

FIG. 23 shows the second substrate after laminating on an adhesive bonding layer;

FIG. 24 shows the second substrate after photolithographic structuring of the bonding layer;

FIG. 25 shows the first and second substrate during the adjustment step;

FIG. 26 shows the first and second substrate during bonding under mechanical pressure;

FIG. 27 shows the completed micro-valve arrangement after application of a piezoelectric actuator;

FIG. 28 shows a schematic representation of a micro-pump with a sealing valve;

FIG. 29 shows a schematic representation of a micro-pump with two sealing valves;

FIG. 30 shows the first and second substrate according to an alternative embodiment during the adjustment step;

FIG. 31 shows the first and second substrate according to an alternative embodiment during bonding under mechanical pressure;

FIG. 32 shows the completed micro-valve arrangement according to an alternative embodiment after application of a piezoelectric actuator;

FIG. 33 shows a plan view of a passage opening in the opened state which is sealed with a plurality of sealing elements;

FIG. 34 shows a further embodiment using a plurality of sealing elements in the opened state;

FIG. 35 shows the arrangement of FIG. 33 in the closed state;

FIG. 36 shows the arrangement of FIG. 34 in the closed state;

FIG. 37 shows a cross-section through a valve assembly with sealing elements on the first and the second substrate in the opened state;

FIG. 38 shows the arrangement of FIG. 37 in the closed state;

FIG. 39 shows a further valve arrangement with a plurality of sealing elements having beveled walls;

FIG. 40 shows a schematic representation of an artificial sphincter system in the continence state;

FIG. 41 shows the sphincter system of FIG. 40 in the defecation state.

### DETAILED DESCRIPTION

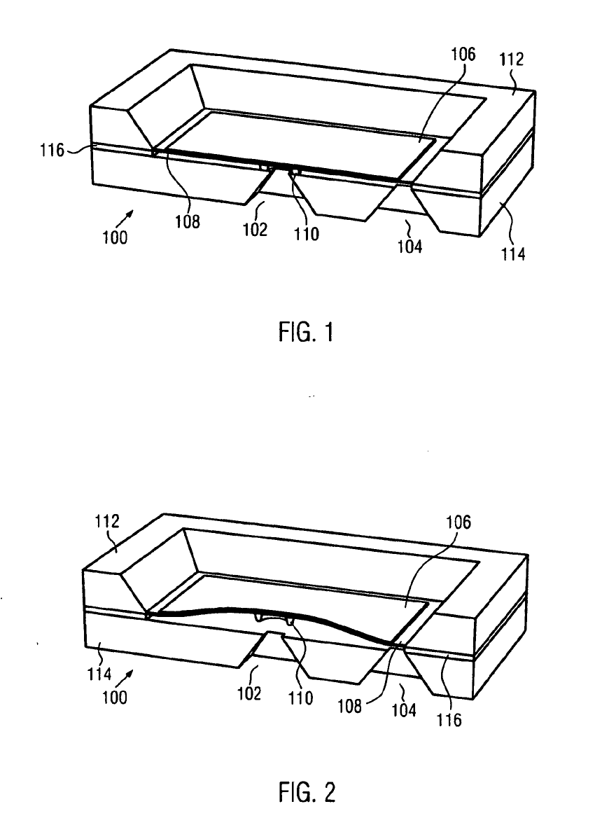

FIG. 1 shows a sectional perspective view of a micro-valve 100 according to the invention according to a first preferred embodiment. The micro-valve 100 comprises a first passage opening 102 and a second passage opening 104 through which fluid (liquid or gas) can flow in or out, respectively. It is by way of example presently assumed, that the passage 102 is an inlet and that the passage 104 is an outlet. However, other arrangements can of course be selected for the openings to be sealed. The micro-valve shown in FIG. 1 has a piezoceramic member 106 as a drive mechanism which is fixedly mounted on a diaphragm 108, for example, adhesively bonded.

In the present embodiment, the diaphragm is a silicon diaphragm 108. The diaphragm, however, can also be formed from other materials. It can be necessary to apply a conductive coating onto the diaphragm side facing the actuator side. It is also possible to apply a structured metallization on the diaphragm side, which allows the piezo actuator to contact directly and without any wire bonding process using known joining methods (gluing, bonding, etc.). Furthermore it is possible to provide the actuator side facing the diaphragm with a structured metallization in order to then mount it on the diaphragm. By applying a voltage to the piezoceramic element 106, the diaphragm flexes, as is generally known, and can be moved both in a direction towards the first passage opening 102 as well as away from the passage opening.

According to the invention, a valve lip 110 is provided for sealing the first passage opening 102. In the illustrated embodiment, the valve lip 110 is attached to the diaphragm which is formed in a first substrate 112. The inlet opening 102 and the outlet opening 104 are formed in the second substrate 114. The two substrates are in the first embodiment firmly joined with each other by means of an adhesive bonding layer 116 of a precisely defined thickness.

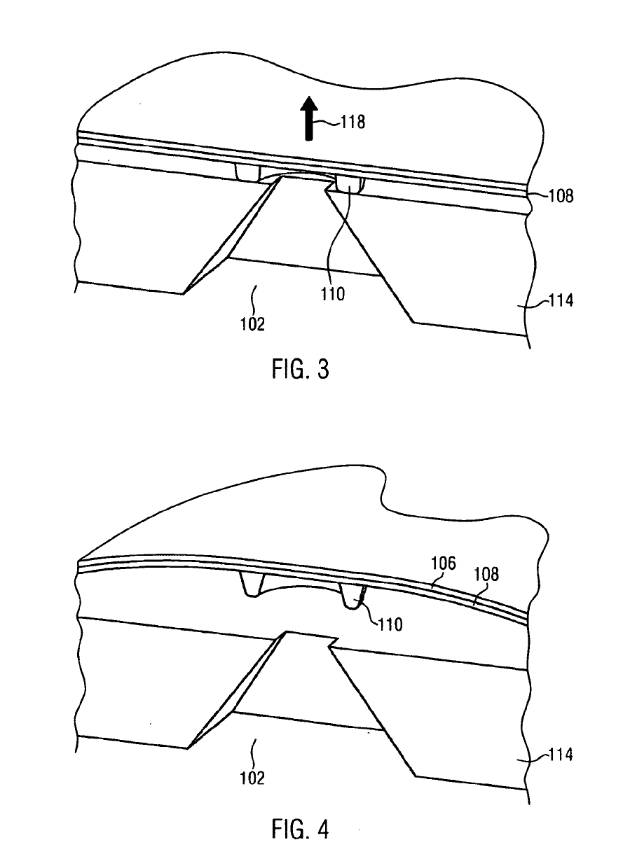

As will be apparent from the following FIGS. 3 and 4, the valve lip 110 is formed from elastically deformable material and is deformed in the closed state of the valve 100 shown in FIG. 1. By means of this elastic deformation in the closed state, a particularly reliable and tight closed position of the valve 100 can be achieved. The embodiment presently shown is a normal-closed valve, i.e., the closed position shown in FIG. 1 is the position at rest being assumed by the diaphragm 108 when the piezo ceramic element 106 is not acted upon by electrical voltage. The advantage of such a normal-closed valve lies predominantly in the fact that no energy needs to be expended for maintaining the closed state.

In FIGS. 3 and 4, the region around the inlet opening 102 is shown enlarged. The valve lip 110 according to the invention has an annular shape and in the embodiment shown, circumferentially encloses the presently rectangular inlet opening 102. In the closed state (shown in FIG. 3), the valve lip 110 is pressed together by a thickness amount which can be set by means of the thickness of the bonding layer 116 (illustrated in FIG. 1) and the height of the seal structure 110. Joining the first and second substrate 112, 114 causes compression of the seal ring 110 corresponding to the thickness of the bonding layer 116, and thereby achieves the normal-closed nature of the valve 100.

If the diaphragm 108 is deflected in the direction 118 due to an electric field being applied to the piezo actuator 106, then the material of the sealing lip initially relaxes. When there is sufficient high diaphragm deflection, a gap finally arises between the sealing lip and substrate on the opposite side through which the fluid can flow (see FIG. 4). After termination of the actuation, the diaphragm 108 returns to its unactuated position and the sealing ring 110 is again compressed and the inlet 102 is thereby sealed against the outlet 104. According to the invention, the soft valve lip 110 dampens the impact and a gradual degradation of the contact partner, particularly during dynamic operation, is avoided. The greater the deformation in the unactuated state, the greater the leakage pressure at the inlet and thus the sealing tightness to be achieved. On the other hand, with less compression, a higher flow rate can be reached during the opened operation.

Numerous experimental studies and computer simulations have shown that the exact structure of the sealing lip 110 (in the illustrated embodiment, an annular-shaped structure having a trapezoidal cross-section) is crucial for the flow characteristics in the opened state and the sealing ability in the closed state. According to the invention, the valve lip is fabricated in a planar technology manufacturing process using photostructurable silicone on the first substrate 112.

For example, photostructurable silicone from Dow Corning, WL-5150, may be used as material for the sealing lip. This material can be used for producing thin layers from 15 to 40 microns or corresponding free-standing structures with aspect ratios of up to 1.3; structure widths of 15 microns are possible. The viscosity of the starting material, which behaves like a negative photoresist, is 450 cPa. The elastic modulus of the processed silicone is 160 MPa, the internal stress on silicon wafers is 2.6 MPa and the tensile strength is 6 MPa. The extensibility is given as 37.6%. Nanoindentation tests have rendered a nanoindentation hardness of 9.5 MPa and a nanoindentation modulus of 300 MPa. Thermal stability is demonstrated up to 300° C. The thermal expansion coefficient is 236·10⁻⁶ 1/K. Moisture absorption, as measured with the pressure cooker test, is at 0.24%. This data is known from the manufacturer Dow Corning: “Dow Corning WL-5150 photo definable spin on silicone notes”, notes, 2006 and Dow Corning: “information about Dow Corning brand low stress patternable silicone materials”, data sheet 2003.

As mentioned above, however, a different polymer can also be used which has an E-modulus of no more than 500 MPa in the final processed state.

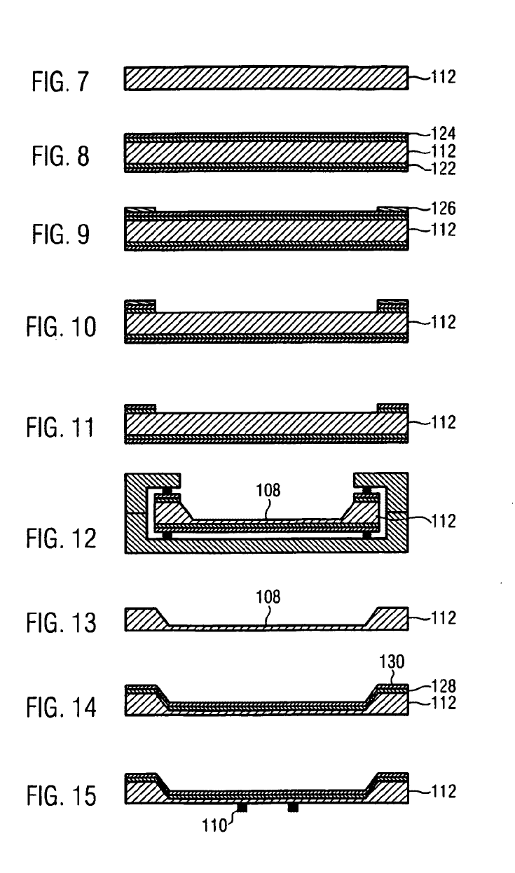

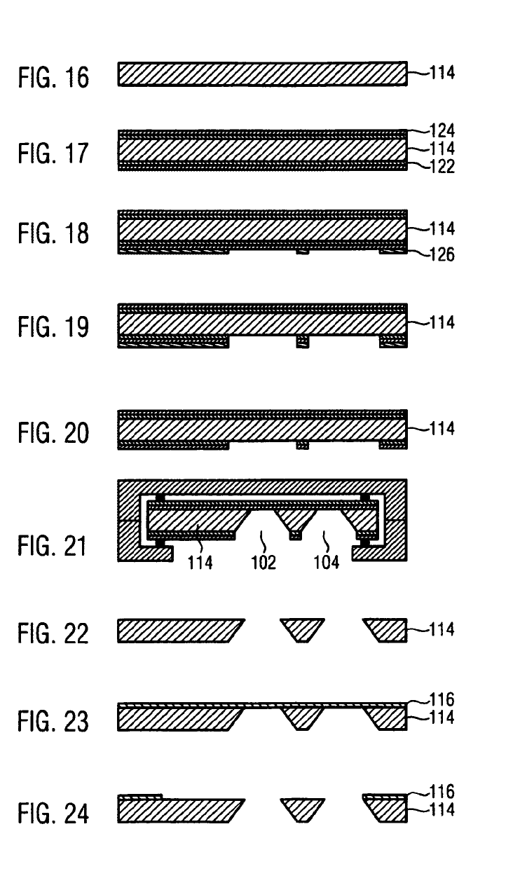

The material, as will be explained in detail below with reference to the FIGS. 7 to 27, is formed in a standard photolithography process on the diaphragm inner surface. This arrangement has the advantage that the wafer, which includes the first substrate 112, is on this surface completely planar and can therefore be coated in a particularly simple manner by spin-coating with the silicone However, it can of course also be intended to have the sealing lip 110 formed on the second substrate 114. Furthermore, sealing structures can be disposed both at the first substrate 112 as well as at the second substrate 114, which cooperate in order to achieve the required seal in the closed state.

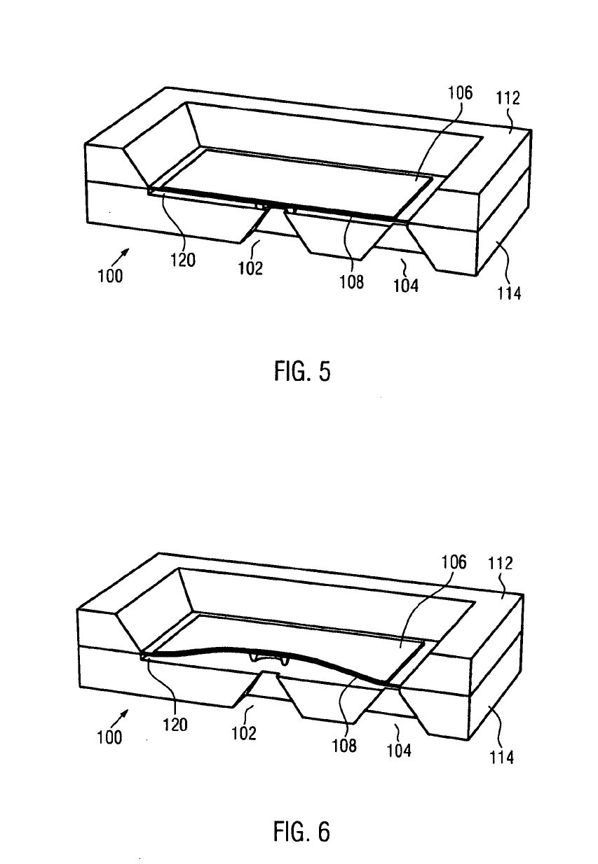

An alternative method of manufacturing the micro-valve 100 according to the invention is explained below with reference to FIGS. 5 and 6. In this, the essential difference to the previously described first embodiment is that the substrates 112, 114 are joined with no additional adhesive bonding layer 116 by means of a direct bonding method. Using silicon direct bonding, as is known per se, the silicon substrates are first either thermally oxidized or they already have a natural oxide layer which is hydrophilized by surface treatment. The surfaces of the wafers to be joined are wetted by water layers comprising only one or two water molecules and contacted with each other. The attractive interaction between the two substrates after this step is based on the formation of hydrogen bonds, which, however, are initially still weak. By tempering the arrangement or by various chemical and physical modifications of the process, the bonding strength can reach the desired values. Alternatively thereto, methods like eutectic bonding or anodic bonding can be used if one of the two substrates is respectively metalized, or is made of glass, respectively. For all bonding methods, attention needs to be paid to a suitable temperature budget, as the elastic material is generally destroyed at high temperatures.

In all joining methods that do not require substantial intermediate layers 116, an etch pit 120 is according to the invention provided in the second substrate 114. By means of the etch pit and the height of the elastic sealing structure, the degree of deformation of the valve lip 110 in the normal-closed state can then be adjusted. For example, such an etch pit can be produced by reactive ion etching.

To a person skilled in the art, is also clear, that adjustment of the deformation of the valve lip 110 can also be determined by a combination of the bonding intermediate layer thickness and an etching pit.

Manufacturing of a valve arrangement according to the invention shall be explained in detail below with reference to FIGS. 7 to 27. This is based on a production of the valve 100 from two silicon substrates. However, depending on the general expertise, other materials can of course also be used. In this, a diaphragm is created on the first substrate by KOH-etching and the side of the substrate later being on the exterior is successively vapor-coated with chrome and gold in order to enable electrical contacting of the actuators. On the sides of the substrate later being on the interior, annular-shaped valve lips according to the invention, made from the photo-structurable silicone Dow Corning WL-5150, are produced.

Passage holes serving as inlets and outlets of the valves are structured in the second substrate likewise by means of KOH-etching. Then a dry photoresist (e.g. ORDYL SY300 from Elga Europe or SU8) is laminated onto the upper side of this substrate and photolithographically structured. The two substrates—still in wafer form—are now brought into contact and joined under pressure. After the separation of the valves, they are fitted with piezo actuators. Here, an electrically conductive epoxy system can for example be used. Finally, the valves are electrically contacted by means of wire connections.

FIG. 7 shows the initial substrate for the first substrate 112. In this, for example, n-type silicon wafers with a (100)-orientation can be used. The wafers have, for example, a diameter of 100 mm and a thickness of 525 microns and are polished on both sides. FIG. 8 shows the first substrate 112 after the growth of 300 nm of moist oxide at 950° C. and the deposition of 100 nm of LPCVD (low pressure chemical vapor deposition) silicon nitride at 760° C. The silicon dioxide layer is designated with the reference numeral 122, the silicon nitride layer with the reference numeral 124. In a next step which is illustrated in FIG. 9, a photoresist 126 is applied and structured. Using the photoresist layer, the nitride layer and the silicon dioxide layer are structured by means of dry etching step (FIG. 10), and subsequently the photoresist is removed in a wet chemical procedure (FIG. 11). FIG. 12 schematically represents the time-controlled wet etching of the substrate 112 in a 30% potassium hydroxide alkaline solution at 60° C. The diaphragm 108 is formed by means of this process step. The masking silicon nitride/silicon dioxide layer 122, 124, as shown in FIG. 13, is then removed by means of 10% hydrofluoric acid. FIG. 14 shows the substrate 112 after a metallization step in which a 20 nm thick chromium layer 128 and a 200 nm thick gold layer 130 are applied.

FIG. 15 shows the photolithographic structuring according to the invention of a spun-on silicone layer for forming the valve lip 110 of the side of the diaphragm 108 opposite to the actuator. In this, as is generally known, the liquid precursor material is first spun on, dried by means of heat treatment and subsequently exposed. The silicone material used is a negative photoresist, so that the exposed areas are cross-linked and later preserved. A further tempering step follows the exposure, and the material unexposed in the exposure step is then removed. A bake-out step completes the processing, in which the material again shrinks by about 2% (acc. to the manufacturer).

For the production of the second substrate 114, the n-type silicon (100) wafers being polished on both sides are in turn again used according to the present embodiment with a diameter of 100 mm and a thickness of 525 microns. The silicon dioxide and the silicon nitride masking layers are applied in analogy to the production of the first substrate and structured by means of a photoresist 126. In the time-controlled wet etching step illustrated in FIG. 21, the passage openings 102 and 104 are formed in the second substrate 114. In order to produce the variant shown in FIGS. 1 and 2 with an adhesive bonding layer 116, for example, a dry photoresist is laminated on, where for example a roller temperature of 100° C. and a laminating speed 0.9 cm per second is used. The region later being on the inside of the valve is exposed by photolithographic structuring.

As is evident from a comparison of the schematic differences in thickness between the sealing lip material 110 and the bonding layer 116 (see FIG. 15 and FIG. 24), the degree of deformation of the sealing lip 110 in the non-actuated state can be set by means of these differences in layer thickness.

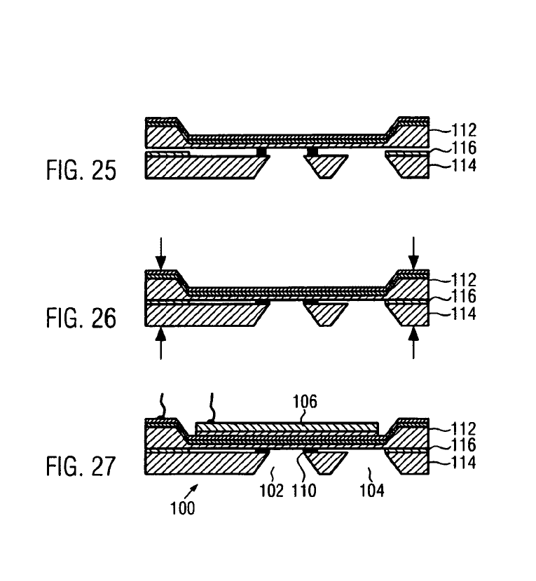

FIGS. 25-27 show the final assembly of the valve structure. In this, the first and second substrate 112, 114 are first adjusted with respect to each other so that the valve lip 110 is respectively disposed above the inlet opening 102. By applying a bonding force of, for example, 60 N/cm² and a bonding temperature of about 95° C., the two substrates are bonded and thereby non-detachably joined to each other. FIG. 27 shows the final product after the piezo actuator 106 was glued-on by means of electrically conductive adhesive and electrically contacted with wires.

For the case that an etch pit is provided, and the two substrates are joined without the bonding layer 116, a respective etching step is performed after the step of FIG. 22.

Apart from this process-related method of achieving a pre-load for the seal lip 110 in the state at rest by means of defined layer thickness ratios, there is also the possibility of making use of the physical principle of mechanical hysteresis of the diaphragm 108. For example, it is known that piezoelectric actuators have such hysteresis in their deformation. A compressively pre-loaded diaphragm also shows hysteretic behavior, regardless of the type of actuation. In this manner, it can be achieved that a residual deflection of the diaphragm 108 is set by respectively having an electrical voltage act upon the piezo actuator for a short time, so that the valve lip 110 remains in a deformed state even after switching off the voltage.

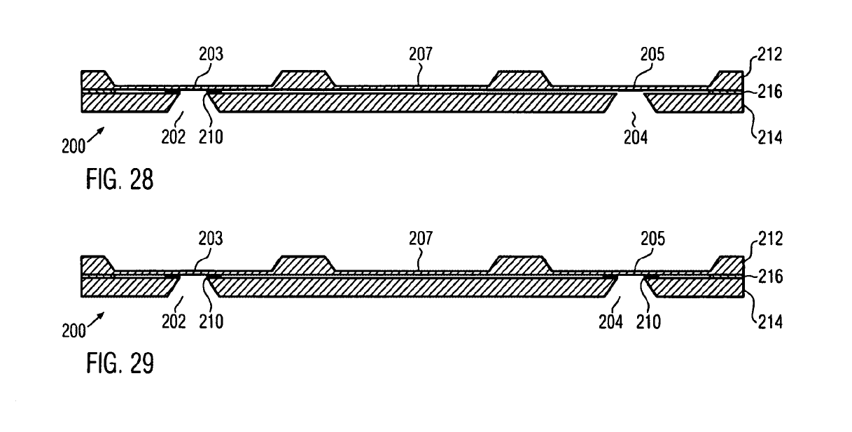

FIGS. 28 and 29 by way of example show two micro-pumps, which were fabricated using the principle according to the invention. They are three-chamber pumps comprising an inlet 202 with a first actuating diaphragm 203 and an outlet 204 with a second actuating diaphragm 205. A third deflectable diaphragm 207 is used for volume displacement, as is generally known. The valve lip 210 according to the invention can be provided only at the inlet 202, or both at the inlet and outlet 202, 204.

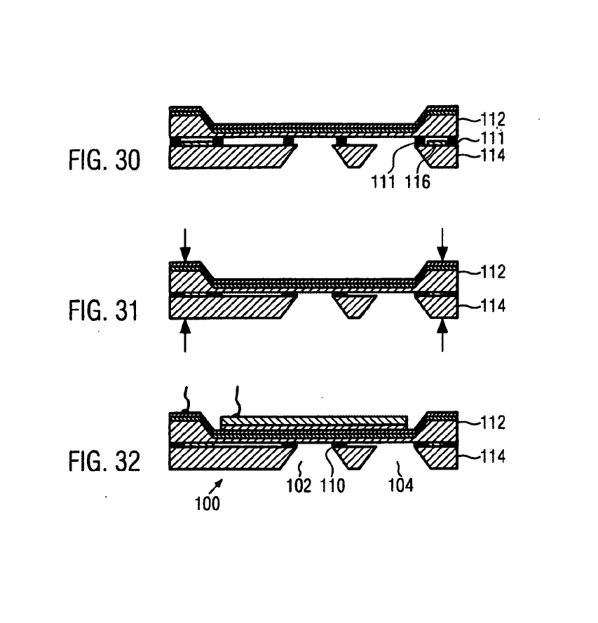

FIGS. 30 to 32 show a further advantageous embodiment of the present valve assembly 100 according to the invention. In this, in addition to the valve lip 110, a further sealing seal structure 111 is provided sealing the connection in a fluid-tight manner between the first and the second substrate 112, 114 both in the direction of the valve chamber as well as to the outer edge regions of the component.

The sealing seal structure 111 can also be dimensioned such that it is compressed in the bonding step of FIG. 31 in order to ensure reliable protection against fluids entering. By means of such an elastic seal 111, as shown in FIG. 32, a circumferential closed seal is created protecting the bonding material 116 from chemical and/or biological substances. In this, the fluid wetting the valve only contacts silicon and silicone. This is of great significance in particular when using an adhesive bonding layer.

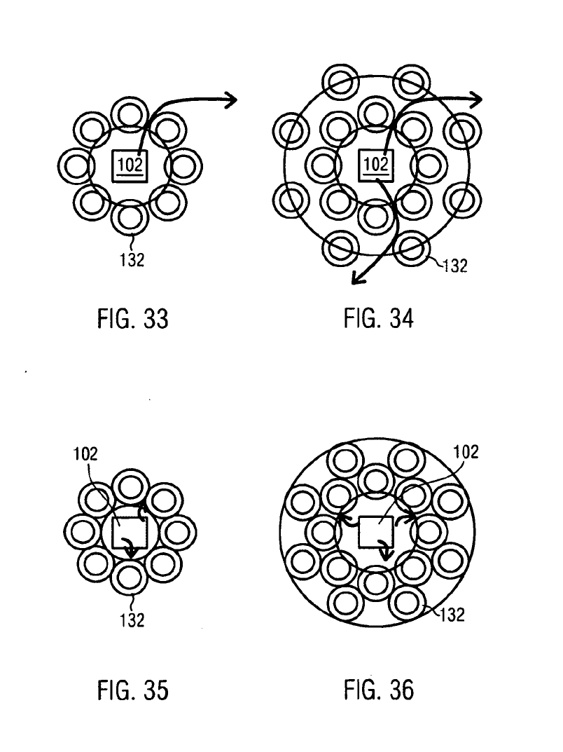

The design of a valve lip according to the invention is not limited only to one-piece, annular, or frame-shaped valve lips 110, as they have been previously shown. Alternatively, multi-part geometries can also be used. The design is such that, with vertical pressure onto the sealing structure, lateral deformation occurs as pronounced as possible (see FIG. 33). For example, column-shaped valve lip elements 132, which presently again have an annular cross-section, can be arranged around the passage opening 102. Two examples of such a multi-part embodiment are shown in FIGS. 33 and 34 each in the opened state. In the opened state, the fluid 134 can flow through between the sealing elements 132 at relatively low fluidic resistance. If, however, the diaphragm sinks and the sealing elements 132 are deformed, then they approach each other to the extent that fluid passage is blocked. This is shown in FIGS. 35 and 36. In this, e.g. in FIG. 36, a plurality of such valve lip elements 132 are disposed in an offset manner, such that a reliable seal of the valve in the closed state is ensured.

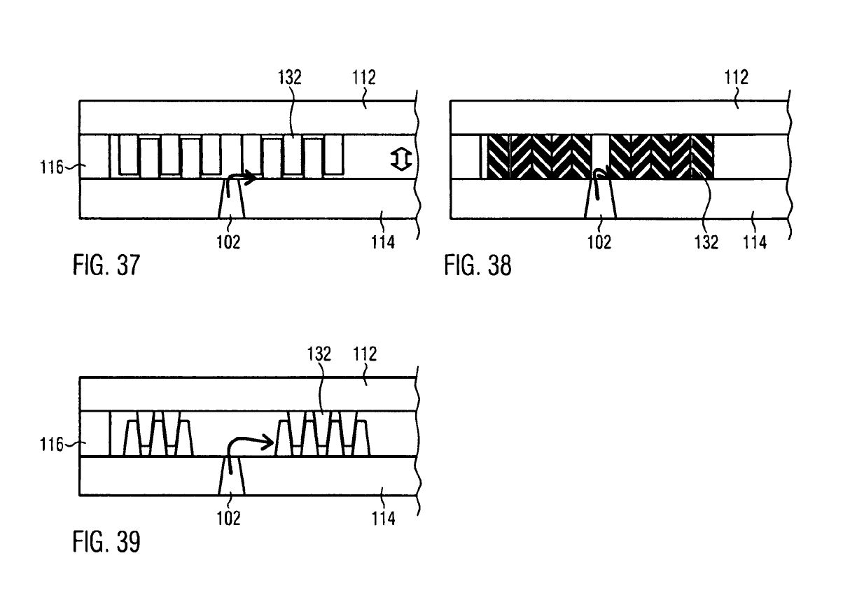

As is evident with reference to FIGS. 37 to 39, the sealing elements do not need to be arranged only on one substrate, but can also in an interlocked manner be disposed on the first and the second substrate 112, 114. In particular when beveled side walls are provided, as is clearly seen in FIG. 39, particularly efficient sealing can be achieved without the need for a large stroke of the diaphragm. Another advantageous embodiment is created when using multi-part column elements, with preferably lateral deformation, which can be positioned at a certain distance to each other on the upper and lower substrate. The sealing effect is created by laterally joining the upper and the lower column elements while subjected to a pressure load.

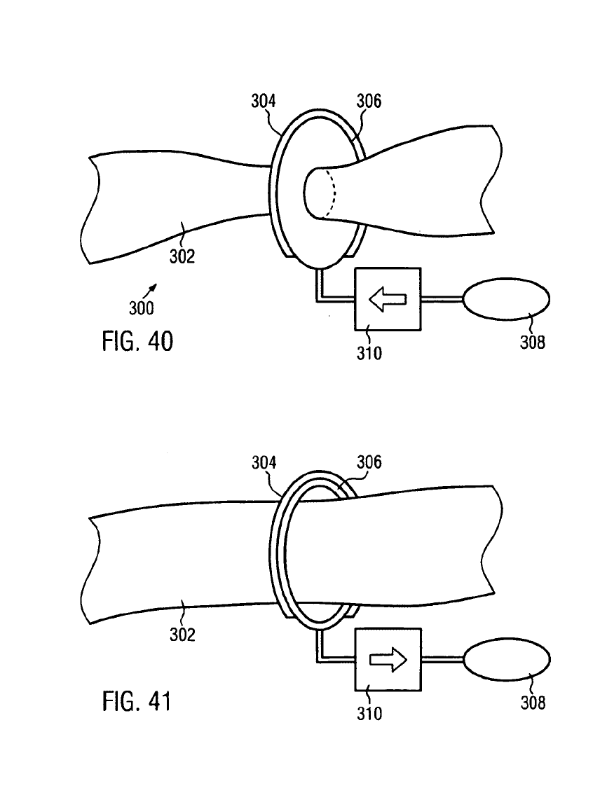

FIGS. 40 and 41 finally illustrate an advantageous field of application for a micro-pump according to the principles of the invention. An artificial annular muscle system 300 which can be used according to a hydraulic principle, for example, for closing a rectum 302, comprises a compressible inflatable body 306 mounted on a support ring 304 and a reservoir 308. By means of the micro-pump 310 according to the invention, the compressible inflatable body 306 is fluidically connected to the reservoir 308. The state shown in FIG. 40 is the so-called continence state in which the larger part of the fluid is located in the compressible inflatable body. The arrangement according to the invention now permits preventing a return flow of the fluid from the compressible inflatable body 306 into the reservoir 308 without any expenditure in energy and with high reliability.

By appropriate control of the pump 310, the fluid can for defecation be pumped into the reservoir 308 and after completion of this process, back into the compressible inflatable body 306.

The pump structure according to the invention has the advantage for the artificial sphincter system 300, that energy must be expended only for the transition processes between the states shown in FIG. 40 and FIG. 41. For maintaining the respective states, no energy input is required and the pump respectively seals in a reliable manner.

By avoiding hard/hard contact between moving and stationary elements of the valve according to the invention, long term stability of the arrangement can additionally be significantly increased.

1. A micro-valve having a first substrate (112) and a second substrate (114) which are non-detachably joined to each other in order to form a controllable fluid flow section, and
with at least one first passage (102) and at least one second passage (104),
where said micro-valve (100) comprises at least one elastically deformable seal structure (110, 111) for sealing against fluid.

2. The micro-valve according to claim 1, where said seal structure for sealing said first and/or second passage (102, 104) comprises at least one elastically deformable valve lip (110).

3. The micro-valve according to claim 2, where said valve lip (110) is under deformation when said valve is closed.

4. The micro-valve according to claim 1 further comprising at least one actuator element (106, 108) for the controlled opening and closing of said first and/or second passage (102, 104).

5. The micro-valve according to claim 4, where said actuator element (106, 108) is operatable for opening said first and/or second passage (102, 104) for forming a normal-closed micro-valve.

6. The micro-valve according to claim 1, where said seal structure further comprises a sealing seal structure (111) for sealing a connection region between said first substrate (112) and said second substrate (114).

7. The micro-valve according to claim 1, where said at least one seal structure (110, 111) is formed in a planar technology manufacturing step on said first and/or on said second substrate (114, 112).

8. The micro-valve according to claim 1, where said seal structure (110, 111) is formed from a polymer having an E-modulus of no more than 500 MPa.

9. The micro-valve according to claim 1, where said seal structure (110, 111) is formed from a photolithographically structured silicone layer.

10. The micro-valve according to claim 2, where said valve lip (110) is formed as one piece, such that it circumferentially seals and encloses said first and/or second passage (102, 104).

11. The micro-valve according to claim 6, where said sealing seal structure (111) is formed as one piece such that it circumferentially seals and encloses a valve chamber.

12. The micro-valve according to claim 6, where said sealing seal structure (111) is formed as one piece such that it circumferentially seals and defines an outer edge region of said micro-valve.

13. The micro-valve according to claim 2, where said valve lip (110) is designed in several parts and comprises a plurality of column-like sealing elements (132) being arranged in an off-set manner, which in the mechanically unloaded state form passage paths having low fluidic resistance and in the mechanically loaded and deformed state block said fluid path by means of greatly increased fluidic resistance.

14. The micro-valve according to claim 1, further comprising a diaphragm (108) being deflectable by piezoelectric or electrostatic actuation for opening and closing said first and/or second passage (102, 104).

15. A micro-pump comprising at least one micro-valve (100) according to claim 1.

16. A hydraulic muscle or spongy body having a compressible inflatable body (306) and a reservoir (308) being fluidically connected with each other, where the fluid between said compressible inflatable body and said reservoir is movable by means of a micro-pump (200, 310) according to claim 11.

17. A method for fabricating a micro-valve, comprising the following steps:
forming a first and a second substrate;
forming at least one first and one second passage opening in said second and/or first substrate;
applying and structuring an elastically deformable seal structure on said first substrate and/or on said second substrate for forming at least one valve lip and/or at least one sealing seal structure;
joining said first and second substrate so that said at least one valve lip seals said at least one first and/or second passage opening in a closed position.

18. The method according to claim 17, wherein said valve lip is formed as one piece such that it circumferentially seals and encloses said passage opening.

19. The method according to claim 17, wherein said valve lip is designed in several parts and comprises a plurality of column-like sealing elements being arranged in an off-set manner, which in the mechanically unloaded state form passage paths having low fluidic resistance and in the mechanically loaded state block said fluid path by means of greatly increased fluidic resistance.

20. The method according to claim 19, wherein a first number of said sealing elements is disposed at said first substrate and a second number of the sealing elements at said second substrate.

21. The method according to claim 17, where in the step of joining said first and second substrate, mechanical pressure is applied to said valve lip in the direction of joining, so that said valve lip is deformed when the valve is closed, in order to form a normal-closed micro-valve.

22. The method according to claim 21, wherein prior to the step of joining said first and second substrate, a bonding layer is applied to at least one of said two substrates, the layer thickness of which at least partially sets a degree of deformation of said valve lip in the closed position.

23. The method according to claim 21, wherein prior to the step of joining said first and second substrate, a recess is attached to at least one of said two substrates, the depth of which at least partially sets a degree of deformation of said valve lip in the closed position.

24. The method according to claim 17, wherein the step of applying and structuring said elastically deformable layer comprises:
spinning on and photolithographically structuring a silicone layer.

25. The method according to claim 17, where in the step of forming a first and a second substrate, a diaphragm is produced on said second or said first substrate as part of an actuator element.

26. The method according to claim 25, wherein said diaphragm is deflected prior to placing said micro-valve into operation, so that said valve lip is deformed when said actuator element is in a position at rest to form a normal-closed micro-valve.

27. The method according to claim 25, further comprising the step of:
applying a piezoelectric actuator for actuating said diaphragm.

28. The method according to claim 25, wherein said actuator element comprises a piezoelectric or electromagnetic actuator with hysteretic behavior.
